(19) United States
(12) Patent Application Publication
(10) Pub. No.: US 2016/0339277 A1
(43) Pub. Date: Nov. 24, 2016

(54) METHOD FOR INSPECTING AN INSIDE ROOM OF A SHIP AND/OR PERFORMING WORKS THEREIN

(71) Applicant: ANCO MARITIME ACTIVITIES LTD., Piraeus (GR)

(72) Inventor: Efthymios ANGELOPOULOS, Plraeus (GR)

(21) Appl. No.: 15/157,077

(22) Filed: May 17, 2016

(30) Foreign Application Priority Data
May 19, 2015 (EP) 15168139.2

(51) Int. Cl. A62B 35/00; E04G 3/00; E04G 3/30

(52) U.S. Cl. CPC A62B 35/0043; A62B 35/0006; E04G 3/305; E04G 3/00

(57) ABSTRACT

The invention relates to a method for inspecting an inside room of a ship and/or performing works therein, wherein the inside room is preferably a cargo tank, a sludge tank, a ballast tank or a cargo hold. The method comprises the following steps:
a) inserting, through an opening preferably provided in a ceiling portion of the inside room, accommodating means (10; 100) for accommodating at least one person;
b) attaching at least one rope (12) at an upper part of the inside room, wherein the at least one rope is attached at the upper part of the inside room
   i. manually by one or a plurality of climbing persons using climbing equipment, and/or
   ii. by means of a drone, and/or
   iii. by means of a pivotable rod; and
c) moving the accommodating means up and down along the at least one rope for inspecting the inside room and/or performing works therein by at least one service person accommodated by the accommodating means.

The present invention relates to a method for inspecting an inside room of a ship and/or performing works therein, wherein the inside room is e. g. a cargo tank, a sludge tank, a ballast tank, a cargo hold, etc.

In accordance with international regulations, cargo tanks need to be inspected periodically to verify that the ship is seaworthy, i.e. to verify that the steel structure has no cracks, corrosion or deformations.

Presently, such an inspection is performed either by erecting a staging or by rafting. The inspection method using a staging requires that the ship is located in a shipyard, where the staging can be erected. Accordingly, an inspection cannot be performed until the ship is located in the shipyard, which results in a loss of time. Furthermore, also the erecting of the staging is costly and time-consuming.

In the method of rafting, the cargo tank to be inspected is filled with seawater of about 1 to 2 meters lower with respect to the ceiling of the tank. Then, an inspecting person is rafting on the seawater surface by using a small inflatable boat. Using the boat, the inspecting person can inspect the inside of the tank at the current seawater level. To inspect lower levels, the seawater level is lowered accordingly. A major disadvantage of this method is that the seawater, which has been pumped into the tank, needs to be discharged to specialized facilities after inspection, since it contains traces of crud oil. As a result, the costs for performing this method are very high.

Another problem is that cargo tanks usually have small access openings not allowing to lower large equipment which is necessary for inspection into the inside of the tank.

Accordingly, it is the object of the present invention to provide a method for inspecting an inside room of a ship and/or performing works therein which can be performed faster and more economical compared to existing methods.

The object of the invention is achieved with a method for inspecting an inside room of a ship and/or performing works therein according to claim 1. Further advantageous developments of the invention are subject-matter of the dependent claims.

According to the invention, a method for inspecting an inside room of a ship and/or performing works therein (wherein the inside room is preferably a cargo tank, a sludge tank, a ballast tank or a cargo hold) comprises the following steps:
a) inserting, through an opening preferably provided in a ceiling portion (roof portion) of the inside room, accommodating means for accommodating at least one person;
b) attaching at least one rope (e.g. a wire rope, a rope made from Teflon or nylon, or a rope made from another material), at an upper part of the inside room, (wherein the at least one rope is preferably connected to the accommodating means before or after attaching the at least one rope at an upper part of the inside room) wherein the at least one rope is attached at the upper part of the inside room
   i. manually by one or a plurality of climbing persons using climbing equipment, and/or
   ii. by means of a drone, and/or
   iii. by means of a pivotable rod; and
c) moving the accommodating means up and down along the at least one rope for inspecting the inside room and/or performing works therein by at least one service person accommodated by the accommodating means.

Since in the method according to the invention, the inspecting/working is performed by using accommodating means which is inserted into the inside room and which is attached, by means of at least one rope, to the upper part of the inside room, the method can be performed very quickly and independently of the specific location of the ship (i.e. the ship does not have to be located in a shipyard). As a result, time and money are saved.

More concretely, the method according to the invention has the advantage that it is faster and cheaper than the inspection method using a staging and it is not required that the ship is located in a shipyard. Compared to the inspection method of rafting, it is cheaper as well and inspection places are not restricted to areas where reception facilities (for receiving the discharged seawater) are available.

The works, which are performed in the inside room of the ship, include for example maintenance and/or repair works. Of course, other types of works are also included.

Preferably, the accommodating means for accommodating the at least one person can be lowered via an opening on the upper part of the inside room (enclosed space) to be inspected. Alternatively, if an opening is provided on the side or bottom of this inside room/space, then the accommodating means can also be inserted via this opening.

Furthermore, for inspecting another part of the inside room of the ship, the at least one rope is simply attached to a different location in the upper part of the inside room. This step is performed as many times as the whole area to be inspected has been checked.

The “upper part of the inside room” is preferably the under deck structure of the inside room/the enclosed space to be inspected. Also, the “upper part of the inside room” can e. g. be the upper part of any longitudinal or transverse structure below the deck level consisting member of bulkhead or other internal structure.

According to an aspect of the invention, the at least one rope is attached manually at the upper part of the inside room. This is done by one or a plurality of climbing persons who are climbing, by means of commonly known climbing/rope equipment, from the bottom of the inside room to the upper part of the inside room, and attach there the at least one rope. This is an easy, flexible and cost saving way for attaching the at least one rope. For example, according to the invention, while one or more service persons inspect and/or work by using the accommodating means, one or more climbing persons connect further connecting means to different locations at the upper part of the inside room. That is, while the service team is inspecting/working in a first section, the climbing team is placing the connection means in a second section. Then, when the service team has finished inspecting/working in the first section, the climbing team connects the at least one rope of the accommodating means to the connection means in the second section. This process is repeated until all necessary areas have been inspected/worked. With this ongoing process of simultaneously inspecting/working and connecting, the expenditure of time for performing the method can be greatly reduced.

According to a further aspect of the invention, the at least one rope is attached at the upper part of the inside room by means of a drone.

To this end, preferably, the rope is secured to the drone such that the rope is in a position which allows an easy attachment of the rope at the upper part of the inside room. In this respect, the rope is advantageously secured to the drone such that the free end of the rope which is to be attached at the upper part of the inside room projects upwardly from the drone.

For releasing the rope from the drone, the drone advantageously comprises a rope release system which is preferably wirelessly operated. An example for such a rope release system is a remote operated release system which releases the rope when the drone operator activates the system. A further example is an automatic release system which releases the wire rope automatically, when the rope has been safely attached (e.g. when a feedback signal from a sensor indicating that the rope has been attached is received). The rope release system can be configured e.g. by a hook, a lockable pin, a clamp, etc.

According to a further aspect of the invention, the at least one rope is attached at the upper part of the inside room by means of a pivotable rod.

Preferably, the method according to the invention includes
a step (b1) of attaching at least one connecting means to the upper part of the inside room, and
a step (b2) of connecting the at least one rope to the connecting means.

In this respect, the at least one connecting means serves to safely secure the at least one rope to the upper part of the inside room. Preferably, step (b1) is performed first, and then step (b2) is performed. Alternatively, it is also possible to connect the at least one rope at first to the at least one connecting means, and then attach the at least one connecting means to the upper part of the inside room.

According to a preferred aspect of the invention, the at least one connecting means is attached manually at the upper part of the inside room by the one or more climbing persons climbing to the upper part of the inside room. This is a very flexible, quick and cost efficient manner of attaching the connecting means.

According to a further preferred aspect of the invention, the at least one connecting means is attached by means of the drone. To this end, the at least one connecting means (which is preferably a clamp as will be described below) is secured to the drone, preferably on top of the drone. When secured to the drone, the position of the connecting means is such that it can be easily attached to the upper part of the inside room. Specifically, if the connecting means is a clamp and the upper part of the inside room is a flange of an under deck structure (such as deck longitudinal or transverse web girder, etc.), then the clamp is in such a position that the clamp socket can be attached to the flange without any parts of the drone interfering with the flange. Also, the clamp is positioned in such a way that any parts of the drone will not touch structural members of the inside room.

Preferably, the drone or the connecting means is provided with a securing system that is able to secure (lock) the connecting means to the drone and release the connecting means with respect to the drone. The securing system is preferably wirelessly operated. The securing system can be configured in the same manner as the rope release system described above. E.g. the securing system can be a remote operated system which locks/releases the connecting means when the drone operator activates the system, or an automatic release mechanism which releases the connecting means from the drone automatically when the connecting means has been safely attached to the upper part of the inside room (e.g. when a feedback signal from a sensor indicating that the connecting means has been attached in the desired position is received). The securing system can be configured e.g. by a hook, a lockable pin, a clamp, etc.

In operation, the drone carrying the connecting means is flown by the drone operator to the required position where the connecting means is attached to the upper part of the inside room.

Preferably, the connecting means is a clamp which comprises a locking/unlocking mechanism which allows a remote controlled or automatically controlled locking of the clamp for attaching the clamp to the upper part of the inside room and which allows a remote controlled or automatically controlled unlocking of the clamp for releasing the clamp from the upper part of the inside room. The locking/unlocking mechanism is preferably wirelessly operated. E.g. the locking/unlocking mechanism can be a remote operated mechanism which locks the clamp for attachment when the drone operator activates the system, or an automatic release mechanism which locks the clamp for attachment automatically (e.g. when a feedback signal from a sensor indicating that the clamp is in its attaching position is received). The unlocking operation of the locking/unlocking mechanism is triggered by an operator (e.g. by sending a corresponding signal from a sender).

The locking/unlocking mechanism of the clamp can be configured by parts which are e.g. electrically, mechanically, pneumatically or hydraulically actuated. If e.g. the locking/unlocking mechanism is electrically actuated, a possible example of the locking/unlocking mechanism comprises a signal receiver and/or transmitter, an electrical actuator and an internal power supply such as batteries, or electrical cables which are connected to an external power supply. When a corresponding lock signal is received from a remote sender/transmitter, which signal is triggered by the drone operator, the signal is received by the signal receiver and/or transmitter and results in that the electrical actuator is brought into its locking position. When the electrical actuator is in its locking position, a signal informing about the locking state is fed back via the remote sender/transmitter to the operator. For unlocking, a corresponding unlocking signal is submitted to the signal receiver and/or transmitter by the operator. Alternatively or in addition, the locking/unlocking mechanism can comprise a position sensor which is advantageously arranged at such a position of the clamp that the position sensor is activated when the clamp has been brought into the desired position for attachment and is allowed to be locked. When the position sensor is activated, the electrical actuator will be brought into the locking position. When the electrical actuator is in its locking position, a signal informing about the locking state is fed back to an operator (e.g. via the transmitter).

In operation, when the drone has flown the clamp to the required position (e.g. when the clamp socket has been brought in position ready for attachment to a structural member of the upper part of the inside room, such as a beam, a flange, a projection, a web frame, a drain hole, a scallop, a cutout and/or a hole), then the locking/unlocking mechanism is operated so that the clamp is locked in position. After that, the above described securing system is operated in order to release the clamp from the drone, and the drone is flown back. For detaching the clamp, the locking/unlocking mechanism is operated so as to unlock the clamp.

Preferably, the connecting means is a clamp which comprises a rope or wire rope securing mechanism for securing the rope to the clamp. The rope securing mechanism can be configured in the same manner as the above described locking/unlocking mechanism. In particular, the rope securing mechanism allows a remote controlled or automatically controlled securing of the rope to the clamp (e.g. by actuating an actuator such as a locking pin which then engages with an eye of the rope) and allows a remote controlled or automatically controlled disconnection of the rope from the clamp. The rope securing mechanism is preferably wirelessly operated.

Depending on the actual use, the clamp can comprise the locking/unlocking mechanism or the rope securing mechanism or both mechanisms.

Preferably, the clamp is made of steel, but more preferably the clamp is made of a light weight material such as aluminum or carbon fibers.

For attachment of the at least one rope or wire rope and the at least one connecting means (preferably a clamp) at the upper part of the inside room by means of the drone, one of the following exemplary processes can be used:
i) The connecting means is attached to the upper part of the inside room at first by means of the drone with a first flight, and then the rope is attached to the connecting means with a second flight. Preferably, to this end, the rope is secured to the drone such that a connection part at the free end of the rope (e.g. a hook, eye, pin or any other commercial connection part) can be easily secured to the connecting means.
ii) One end of the rope is attached to the connecting means at first, and then the connecting means and the rope or wire rope are flown together by means of the drone to the required position for attachment of the connecting means. Advantageously, in this case, if the connecting means is a clamp, there is no need for the clamp to have a remote operated rope securing mechanism. Alternatively, the rope is passed through the connecting means (preferably, the rope is passed through the connecting means, e.g. via a pulley of the connecting means) at first, and then the connecting means is flown into position while the rope is suspended by the connecting means and while both ends of the rope are held at the bottom of the inside room. After the connecting means has been attached, the free end of the rope is fixed to a structure of the inside room.
iii) An end of a light weight rope, i.e. a guide line, is attached to an end of the rope at first. Then the guide line is connected to the connecting means so that it can be moved relatively to the connecting means (preferably, the guide line is passed through the connecting means, e.g. via a pulley of the connecting means). The connecting means and the guide line are then flown together by means of the drone to the required position for attachment of the connecting means, while the free end of the guide line is still held at the bottom of the inside room. When the connecting means is attached, an operator pulls from the bottom of the inside room, the free end of the guide line thereby lifting the rope upwards into the desired position for fixing the rope to the connecting means. The rope can then be secured to the clamp by means of the rope securing mechanism. Alternatively, the rope is not fixed to the connecting means, but the operator pulls the guide line further until a part of the rope has passed through the connecting means and then the free end of the rope (end which is connected to the guide line) is fixed to a structure in the inside room. That is, the rope is suspended by the connecting means. The use of the guide line is in particular in those cases advantageous where the weight of the rope and the clamp exceed the lifting capacity of the drone.

The above processes including the step of moving the accommodating means up and down along the at least one rope or wire rope for inspecting the inside room and/or performing works therein by at least one service person accommodated by the accommodating means are repeatedly performed in the same manner as described with respect to the manually attaching of the rope by means of the climbing persons until all necessary areas have been inspected/worked.

Although in the above cases, the at least one connecting means is a clamp, the drone can also carry a wire sling or a rope sling positioned on the drone such that the end of the sling can be passed through an opening provided at the upper part of the inside room (e.g. a drain hole, scallop, etc.). After the sling has been installed in this manner at the upper part of the inside room, it can be released from the drone via a remote operated mechanism which is similar to the securing system described above.

As mentioned above, according to a further aspect of the invention, the at least one rope is attached at the upper part of the inside room by means of the pivotable rod. The pivotable rod consists of a rod (which is advantageously configured to be telescopically so that it can be extended or contracted) and a base on which one end of the rod is pivotally supported firmly attached, preferably to the bottom of the inside room. Preferably, the rod is pivotable in only one direction (preferably in the vertical direction). However, the pivotable rod can also be configured such that it can be pivoted in more than one direction (preferably in the horizontal direction as well as in the vertical direction). The pivotable rod is configured such that a free end of the rod can be lifted upwards with a pivoting movement around the support. The upward movement can be achieved e.g. manually by means of lifting ropes attached to the free end of the rod, which lifting ropes are pulled by one or more operators. In case the rod is pivotable in more than one direction, the rod's rotation/pivoting direction can be easily controlled by means of the lifting ropes. In order to reduce the necessary pulling force for the one or more operators, the upward movement can also be assisted by using e.g. a pulley system or an electric, pneumatic or hydraulic motor. A configuration is also possible, where the upward movement is controlled/effected by using only motor assistance.

For attaching the at least one rope or wire rope to the upper part of the inside room, the following processes can be used:
i) The pivotable rod is positioned preferably on the bottom of the inside room which is to be inspected. The at least one rope or wire rope is secured to the free end of the rod. Then, the rod together with the at least one rope is lifted upwards until the rope or wire rope is at the desired position for attachment. Then, the rope is attached directly to a structure of the upper part of the inside room (e.g. by a climbing person) or is passed e.g. via/through a drain hole or scallop of the structure without the assistance of climbers. That is, in case the rope is passed via/through a drain hole or scallop, a first movement of the rod is used in order to bring the wire rope through/over the drain hole or scallop. Then, after the rope has been shortly released from the wire rope, the rod is again used for bringing the securing means/engaging mechanism of the wire rope with a second movement of the rod to the desired location in order to secure the wire rope into location. The securing means/engaging mechanism can be e.g. either a hook or a key or a D-shackle which connects the two ends of the wire rope or which connects one end of the wire rope to another portion of the wire rope. Alternatively, the pivotable rod is passing a light weight rope or wire rope via/through the scallop or drain hole with a first movement, which is then pulled downward with a second movement of the rod until it reaches the bottom of the tank where the operator can secure the light weight rope or wire rope to the bottom of the tank. By doing so, the wire rope used by the accommodating means is passed via the scallop and secured at the bottom of the inside room. Alternatively, the wire rope is attached to a connecting means which has been attached to the upper part of the inside room in advance. If the connecting means is a clamp and comprises a rope securing mechanism as described above, the rope or wire rope can be advantageously secured to the clamp by means of remote control.
ii) The pivotable rod is positioned preferably on the bottom of the inside room which is to be inspected. On the free end of the rod, the at least one connecting means (preferably a clamp or wire sling) is secured, with the at least one rope or wire rope being connected to the connecting means. Then the rod's free end is lifted upwards together with the connecting means and the rope or wire rope connected thereto. When the connecting means has been brought into the desired position, the connecting means is attached to the upper part of the inside room. The connecting means is advantageously a clamp having a locking/unlocking mechanism as described above, so that the clamp can be attached (and afterwards also be detached) by means of remote control.

The above processes including the step of moving the accommodating means up and down along the at least one rope for inspecting the inside room and/or performing works therein by at least one service person accommodated by the accommodating means are repeatedly performed in the same manner as described with respect to the manually attaching of the rope by means of the climbing persons until all necessary areas have been inspected/worked.

The different methods of attaching the at least one rope or wire rope and the at least one connecting means by means of one or a plurality of climbing persons using climbing equipment, by means of the drone, or by means of the pivotable rod that have been described above, are not methods which have to be performed separately, but which can also be combined with each other. E.g. the drone or the pivotable rod can be used to lift up the rope to a climbing person who has climbed up to the upper part of the inside room and who finally attaches the rope to the upper part. As a further example, the connecting means is attached by means of the pivotable rod, while the rope is then attached to connecting means by means of the drone. Thus, a plurality of different combinations of the methods is possible.

Preferably, each rope is provided with an engaging mechanism, such as a hook loop, eye, pin, etc., at its end which is engaged into the connecting means for connecting the rope to the connecting means. Especially the hook, which is hooked into the connecting means, is a very quick and easy way of connecting the rope to the connecting means, and is especially favorable when the at least one rope is connected to the connecting means by the before-mentioned climbing persons. Alternatively, each rope can be provided with a different means at its end for connecting the rope to the connecting means, such as e.g. a D-shackle.

Preferably, the connecting means is at least one of a clamp (such as for example a clamp for an “L-type beam”, a clamp for a “T-type beam”, a clamp for a “Holland profile structural member”, or the clamp as described above), a trolley (e.g. a trolley which is movable along a beam or rope, wherein the trolley can e.g. be operated by hand or by a motor) and a wire sling. The connecting means is selected depending on the structure of the upper part of the inside room, where the connecting means is to be attached. In this respect, also a combination of one or more clamps, one or more trolleys and/or one or more wire slings is possible depending on the structure of the upper part. Compared to clamps, which are fixedly attached to the upper structure of the inside room, trolleys have the advantage that they can be moved along the structural members (for example T-beams, L-beams, or ropes) on which they are attached (for example they can be moved in the transverse direction or longitudinal direction), thereby offering a greater flexibility and a quicker inspection/working. In this respect, when such trolleys are, for example, attached on a flange of two web frames (e.g. two trolleys on one web and two trolleys on a next web), then stoppers can be inserted, in order to prevent the trolleys clamps from moving downward, since, usually, a flange of a web has a downward slope towards the end. This applies also to other structures which are sloped downward. Further, the stoppers can also be placed for safety reasons in any case.

Preferably, in case the connecting means is a trolley, the method includes the step of shifting the accommodating means connected to the trolley by shifting the trolley along the structural member (such e.g. a beam and/or a rope) to which it is attached to (in case the connecting means comprise plural trolleys, this step may include the step of shifting the accommodating means connected to the trolleys by shifting the trolleys along same or different structural members to which they are attached to). With this step, the accommodating means can be shifted easily to a new area to be inspected/to be worked. If two trolleys are used from each side of the accommodating means (preferably a platform) then the trolleys are preferably connected to each other in such a way that they are moving together at constant distance to each other. Furthermore, a brake is preferably available on the trolleys to avoid unintended movement. If trolleys with brakes are not available, then e.g. stoppers can be placed along the beam (T-beam) or rope, to which the trolleys are attached to. Stoppers can be moved along the movements of the trolleys. Preferably, two sets of stoppers are available from each side of each trolley; one in contact with the trolley and one in next position. So, when an operator removes the stopper in contact with the trolley, the trolley will roll to the next stopper. For safety reasons, preferably two stoppers from the opposite side of the trolley are always installed. When the trolley rolls to next position then the stopper from the opposite position should also be moved.

The at least one connecting means is e.g. attached to a beam, a flange, a projection, a web frame, a drain hole, a scallop (being a type of a cutout in the internal structure of the inside room/cargo tank, which is positioned either on deck longitudinal or other internal structural member or on transverse webs; an example of a scallop is the cutout on a transverse web frame that is required in order to pass the deck longitudinal through the transverse web), a cutout and/or a hole provided in the upper part of the inside room. That is, any suitable structure in the upper part of the inside room can be used as an attaching portion for attaching the connecting means. Accordingly, the method of the invention is very flexible regarding the attachment location of the connecting means.

Preferably, the accommodating means is provided with at least one rope, preferably two ropes, at each longitudinal end thereof. In case the accommodating means is provided with two ropes at the end, the accommodating means is safer in case one wire or connecting means fails.

Preferably, the accommodating means is provided with at least one drive source, preferably two drive sources, for moving the accommodating means up and down along the ropes. In case of two drive sources, each drive source is preferably provided at one longitudinal end of the accommodating means. The drive source(s) can for example be electrically-operated, air-operated, manually operated or operated by an internal combustion engine.

Preferably, the accommodating means is a platform. However, it can also be a box, a chair, a safety harness, etc.

Preferably, in case the accommodating means is a platform, the platform is configured such that it can be disassembled. This enables that the platform can be inserted through also very small openings provided in the ceiling portion of the inside room. For this purpose, preferably, the platform is configured such that it can be passed, in its disassembled state, through an opening having a diameter of equal to or less than 1400 mm×800 mm, and preferably through an opening having a diameter of equal to or less than 400 mm×600 mm.

Preferably, in case the accommodating means is a platform, the platform is, in step a), inserted in a disassembled state (in a partly or fully disassembled state), and is then, after insertion, assembled in the inside room. This allows the insertion of the platform through comparatively small openings provided in the ceiling portion of the inside room.

Preferably, the opening provided in the ceiling portion of the inside room is a manhole or an access opening.

Further preferably, the opening provided in the ceiling portion of the inside room is positioned on a deck plating of the ship.

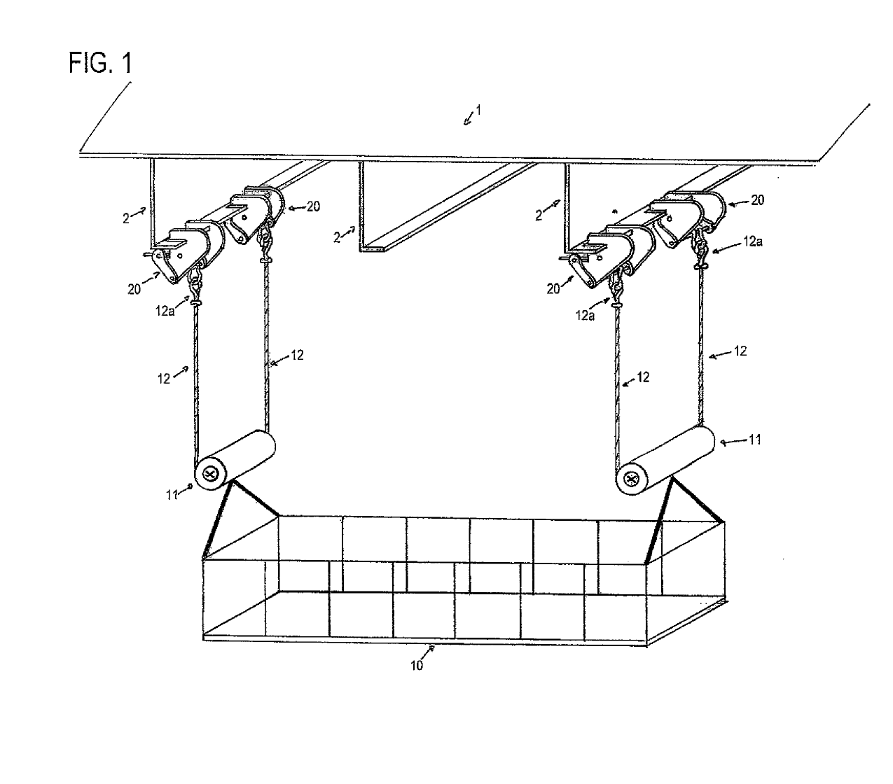

FIG. 1 is a schematic view showing a platform attached to an under deck structure of a cargo tank.

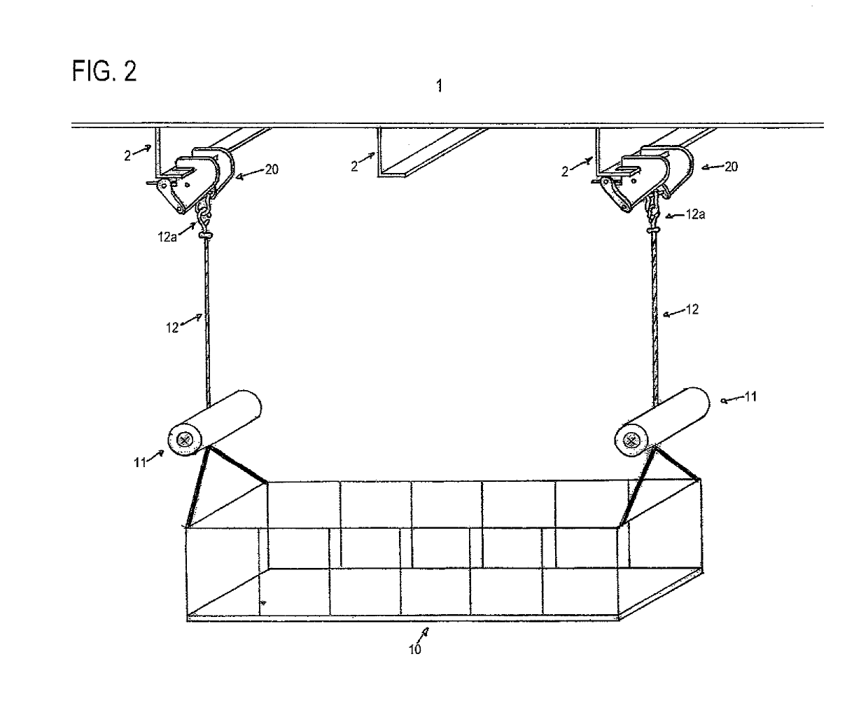

FIG. 2 is a schematic view showing a modification of the platform shown in FIG. 1.

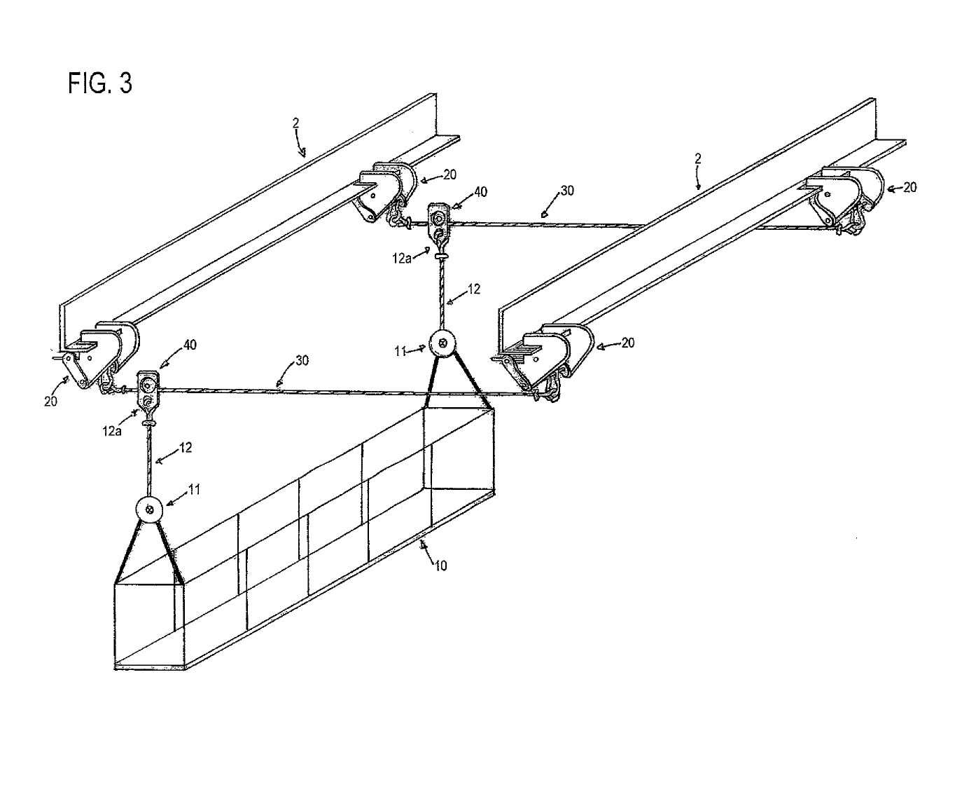

FIG. 3 schematically shows an alternative way of attaching a platform to an under deck structure.

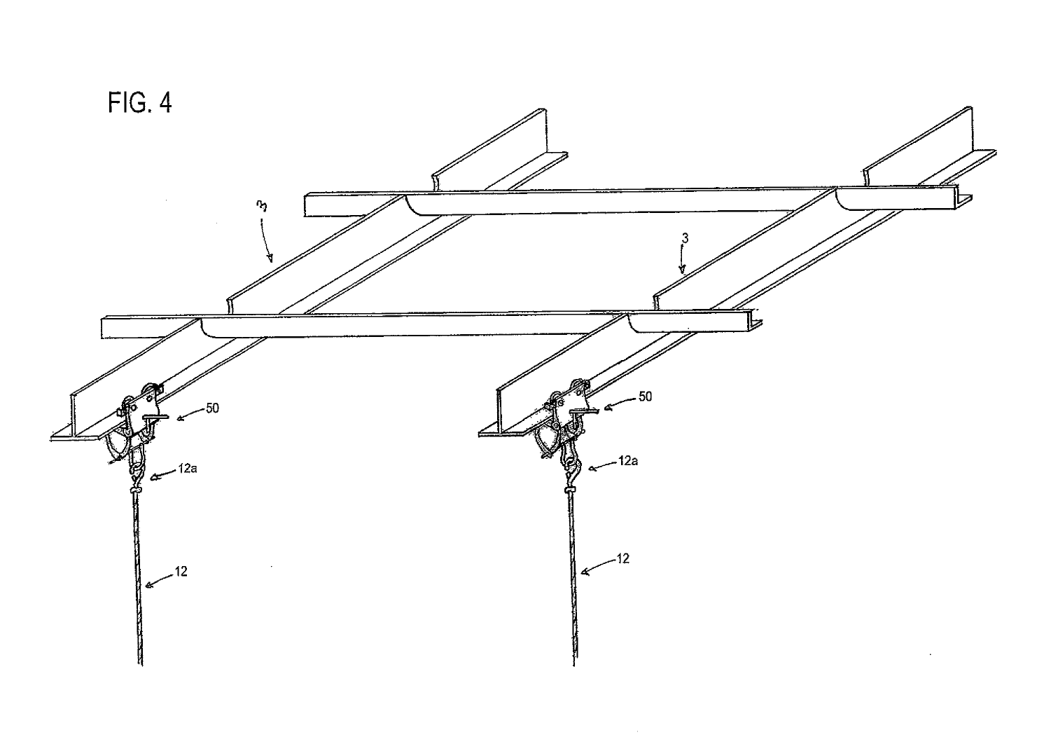

FIG. 4 schematically shows a further alternative way of attaching a platform to an under deck structure.

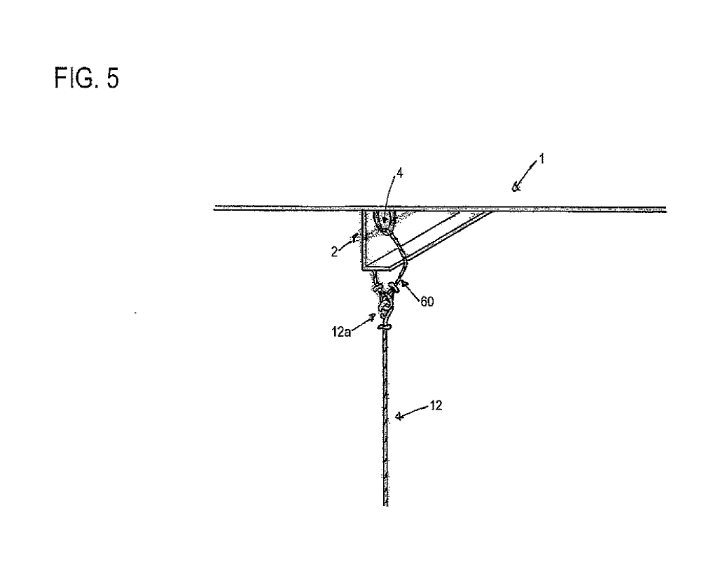

FIG. 5 schematically shows a further alternative way of attaching a platform to an under deck structure.

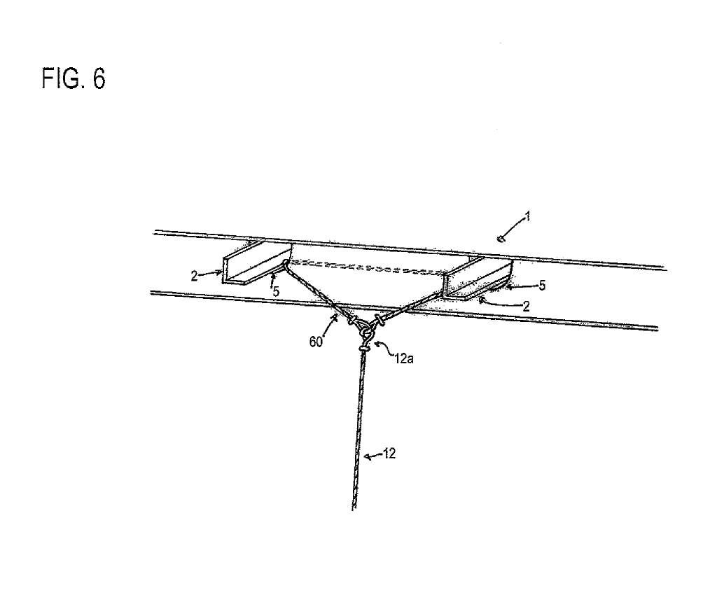

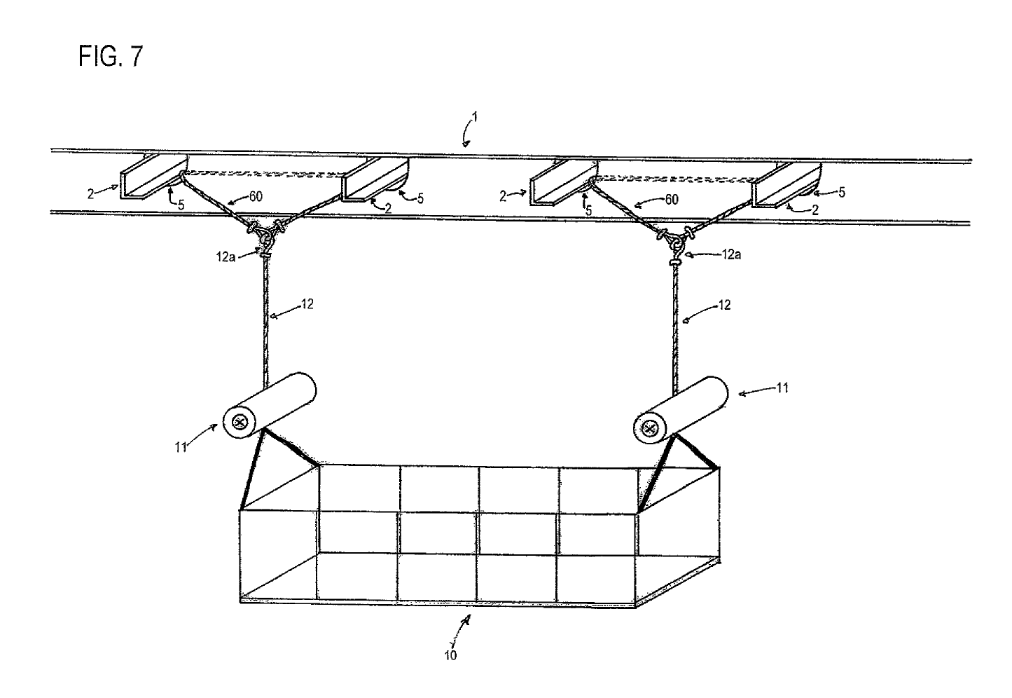

FIGS. 6 and 7 schematically show a further alternative way of attaching a platform to an under deck structure.

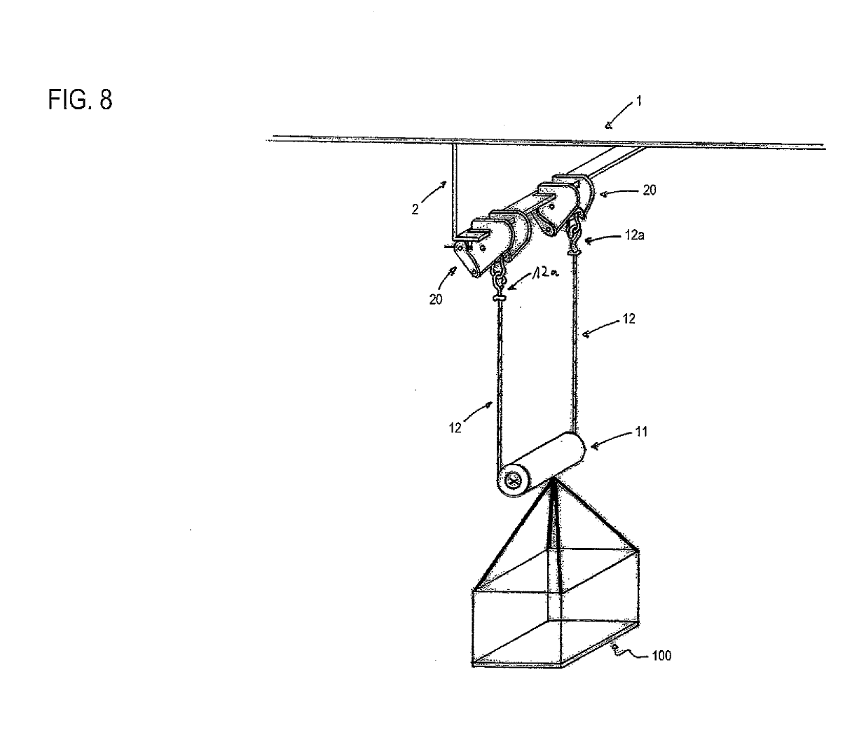

FIG. 8 schematically shows a way of attaching accommodating means for a single person to an under deck structure.

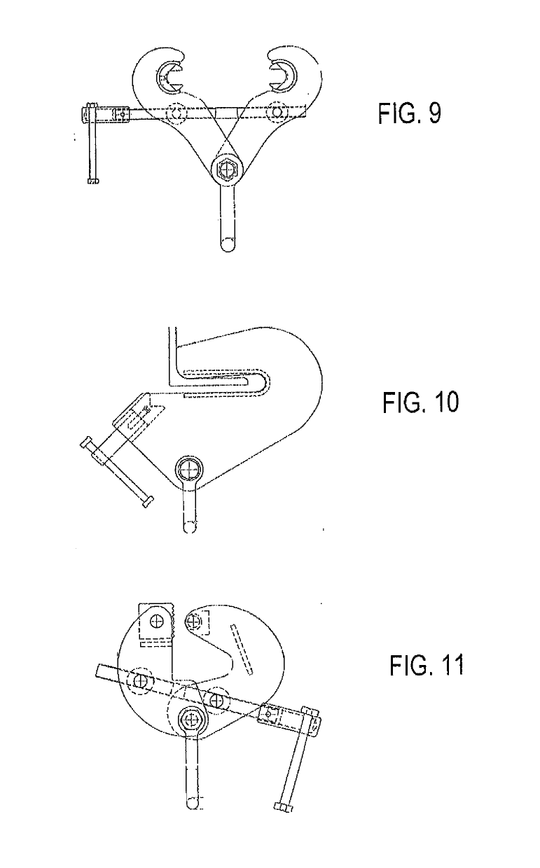

FIGS. 9 to 11 schematically show different types of clamps.

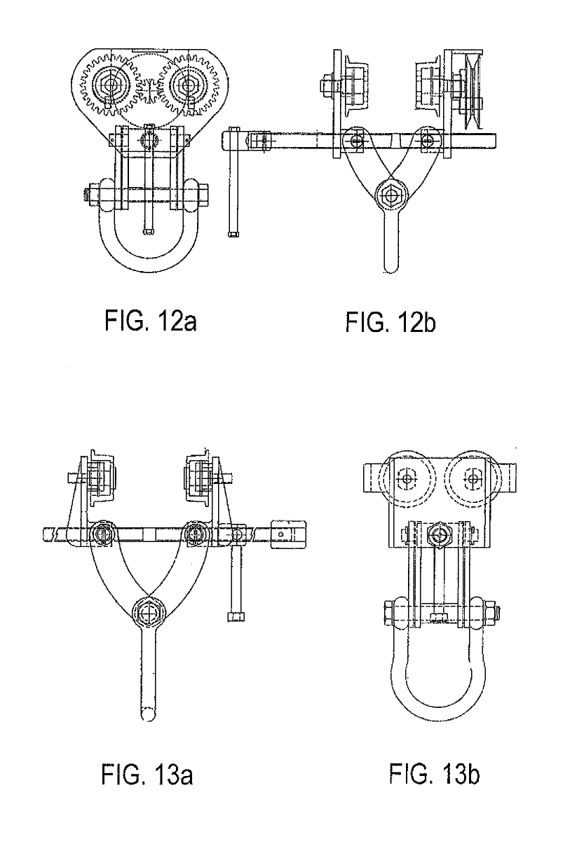

FIGS. 12a, 12b, 13a and 13b show different types of trolleys.

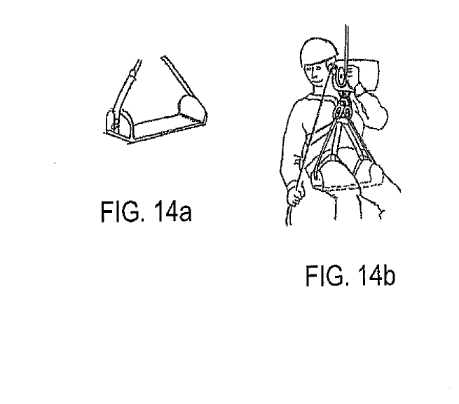

FIGS. 14a and 14b schematically illustrate a chair/harness combination and how a service person can use a hoist mechanism to be elevated to an upper part of the inside room of a cargo tank.

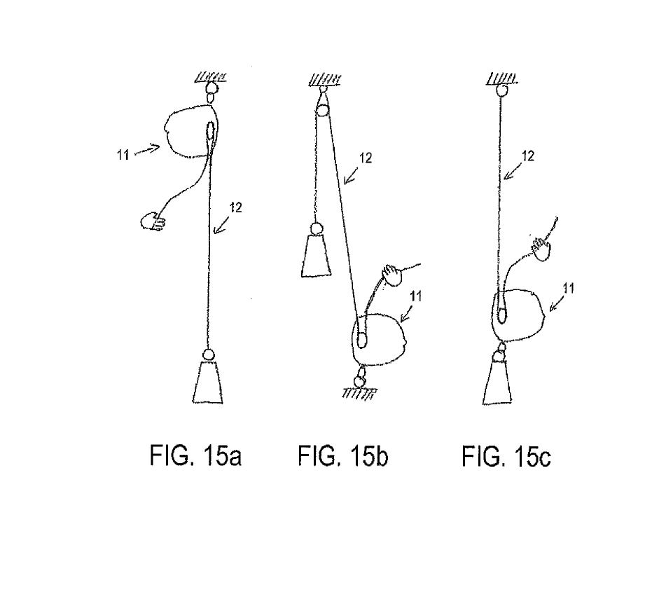

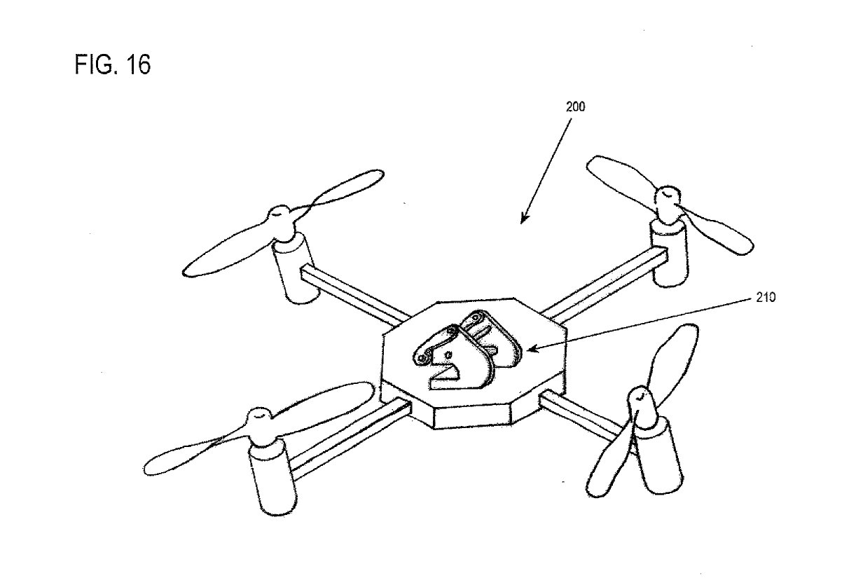

FIGS. 15a to 15c schematically illustrate different ways of connecting a hoist mechanism (in these Figures, the weight symbol represents either a service person or a box or a platform, and the small hand represents a free end).

FIG. 16 schematically shows an example of a drone for use in the method according to the invention, wherein a clamp is secured on the upper side of the drone.

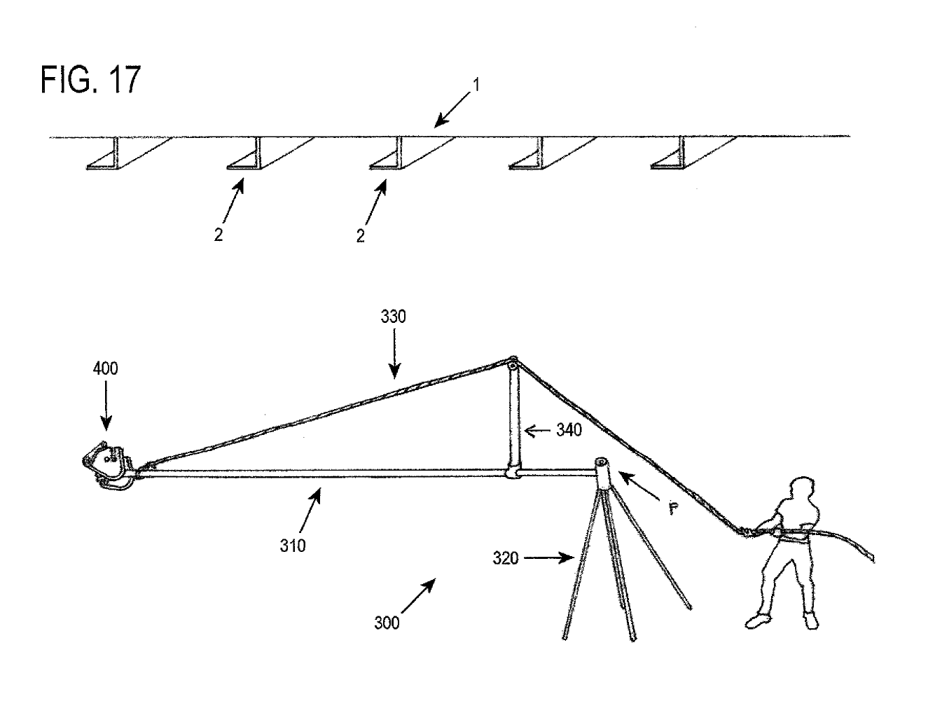

FIG. 17 schematically shows an example of a pivotable rod for use in the method according to the invention.

Below, a preferred embodiment of the invention will be described with reference to the drawings. In the drawings, the same reference numerals are given to the same/equivalent elements.

In this embodiment, a cargo tank is taken as an example for an inside room of a ship, which is to be inspected and/or in which works are to be performed.

The cargo tank is provided with a manhole or an access opening in its ceiling (roof) portion through which the interior of the cargo tank is accessible.

At first, all equipment (such as e.g. platform as an example for accommodating means, ropes, clamps, etc.) necessary for performing the method is prepared outside the cargo tank. Then the equipment is lowered into the tank, for example, by means of ropes. Since the manhole or access opening is usually very small (smaller than e. g. 1400 mm×800 mm, sometimes smaller than 400 mm×600 mm, wherein the opening usually has an oval shape), the overall dimensions of the platform are too large in order to be passed through the manhole/access opening. For this reason, the platform is, in this example, configured such that it can be dissembled into small pieces which can then be passed through the manhole/access opening. Accordingly, in this example, the platform is inserted in its dissembled state through the manhole/access opening. After the platform has been inserted into the cargo tank, it is assembled inside the tank. This assembly can include a mounting of the drive sources (e.g. electric or air-operated motors or a manually operated drive source or a small internal combustion engine) to the platform and a mounting of wire ropes to the platform/drive sources motor.

Then, a climbing team attaches plural connecting means (such as e.g. clamps, trolleys, wire slings) to the upper structure of the cargo tank, with the climbing team using standard rope/climbing equipment.

As the next step, the wire ropes of the platform are connected to the connecting means. This is also done by the climbing team.

After the wire ropes have been attached to the connecting means, the platform is ready to be used. Usually, a service team of two or three service persons (also one service person is sufficient; there also can be more than three service persons) enters the platform and lifts, by means of the drive sources, the platform up and down along the wire ropes for inspecting the cargo tank and/or performing works therein, such as repair and/or maintenance works. While the service team inspects/works inside the cargo tank in a first section, the climbing team attaches connecting means to a next section in which inspection/work is to be performed. After the service team has finished their inspection/work in the first section, the platform is connected to the connecting means of the next section in the same manner as described before. This process is repeated until all sections of interest have been inspected and/or worked. In order to save time and energy, it is possible that the climbing team stays hanging next to the connecting in order to avoid climbing up and down every time the platform is moved to the next location. For this purpose, they use special chairs which are standard rope/climbing equipment.

Although the embodiment has been described with respect to a cargo tank, the invention is not limited to the cargo tank and, for example a sludge tank, a ballast tank, a cargo hold, etc. are possible locations where the method can be carried out. The method according to the invention can e.g. be used in cargo holds of bulk carriers for the inspection of side shell frames or under deck structure. In this case, the climbing team can attach clamps for an L-type or T-type beam to the upper part of side shell frames or wire slings at a scallop or cutout in the same way as attached on the under deck structure of the cargo tank. Then, after the climbing team has connected the hooks of the wire ropes to the clamps, the platform can move up and down along the side shell frames. The procedure is same as the one inside a cargo tank as described above.

FIG. 1 schematically shows an example of attaching a platform to an under deck structure of a cargo tank in accordance with the method of the invention. Specifically, FIG. 1 shows a deck 1 being a ceiling/roof portion of a cargo tank (the access opening/manhole is not shown). The upper part of the cargo tank (under deck structure) is provided with L-beams 2. A platform 10 is attached to the L-beams 2 via connecting means in the form of clamps 20 which have been fixedly attached to the L-beams 2. The platform 10 is provided, at each longitudinal end, with one electric motor 11 as drive source and two wire ropes 12 (one of the two wire ropes 12 is connected to one of the electric motors 11, and the other of the two wire ropes 12 is attached to a self arrest device for safety reasons). The wire ropes 12 have, at their ends, a hook 12a for easy connection/disconnection to the clamps 20. In particular, the hooks 12a are hooked into well-known “D” shackles of the clamps 20. In this state, the platform can be moved up and down, by means of the electric motors 11, along the wire ropes 12 by a service team for inspecting/working in the inside of the cargo tank.

FIG. 2 is a schematic view showing a modification of the platform shown in FIG. 1. Compared to the platform shown in FIG. 1, the platform 10 shown in FIG. 2 comprises, at each longitudinally end, a single electric motor 11 and a single wire rope 12. Accordingly, this platform 10 requires only two clamps 20 for mounting to the under deck structure of the cargo tank.

FIG. 3 schematically shows an alternative way of attaching a platform to an under deck structure. Specifically, four clamps 20 are attached to two L-beams of the under deck structure. Connecting ropes 30 (e.g. wire ropes) are respectively suspended between (are fixed to) two opposed clamps 20 attached to L-beams 2 positioned at a distance. Trolleys 40 are respectively mounted to the connecting ropes 30 such that they can be moved (e.g. by hand or by a motor) along the connecting ropes 30. The platform 10 is connected to the under deck structure by connecting the hooks 12a of the wire ropes 12 to the trolleys 40. As an advantage of this configuration, the platform 10 can be easily shifted to another location by means of the trolleys 40. For additional safety two connecting ropes 30 and two clamps 20 can be installed from each side instead of one as indicated in FIG. 3.

FIG. 4 schematically shows a further alternative way of attaching a platform to an under deck structure. In this example, the wire ropes 12 are attached to trolleys 50 which are directly mounted on T-beams 3 forming the under deck structure.

FIG. 5 schematically shows a further alternative way of attaching a platform to an under deck structure. In this example, a wire rope 12 is attached to a wire sling 60 which is passed through a hole 2a formed in the L-beam 2.

FIGS. 6 and 7 schematically show a further alternative way of attaching a platform to an under deck structure. As shown in these drawings, L-beams 2 are passed through a cutout 5 of a transverse web frame. Wire slings 60 are respectively passed through neighbouring cutouts 5 (so as to surround the part of the transverse web frame between the cutouts 5), and the wire ropes 12 of the platform 10 are attached to these wire slings 60.

Alternatively, a single hoist mechanism can be provided in order to lift a box 100 that can accommodate one person, as illustrated in FIG. 8. As illustrated, the box 100 is provided with a single drive source 12, and the two wire ropes 12 thereof are attached to a single beam 2 by two clamps 20. This configuration can work either with one wire rope 12 (not illustrated) or two wire ropes 12 (as illustrated) for increased safety.

Instead of box 100, a climbing chair (as illustrated in FIGS. 14a and 14b), can be attached to the hoist mechanism where a service person can seat on and be lifted by the hoist. The service person wears a safety harness and is secured to the lifting rope and an independent life line. After the service person has inspected the intended area and then has lowered to ground level, the hook of the wire rope or rope is transferred to the next anchor point that has been installed by the climbing team. By repeating this process the complete structure can be inspected.

Alternatively, the service person, if wearing a climbing harness, can be secured directly to the hoist mechanism or rope so he/she can be lifted directly without the use of a climbing chair. A secondary life line with self arrest mechanism should be available also for safety reasons.

The hoist mechanism is preferably operated by means of the drive source 11 for moving the service person as mentioned above. To this end, the hoist mechanism is placed at a fixed point on the ship, as illustrated by FIGS. 15a to 15c.

In the example shown in FIG. 15a, the drive source 11 is attached in the upper part of the space to be inspected. One end of the rope 12 is attached to the weight (climbing harness, platform, box, etc.; indicated by the weight symbol) and the other end is free (the free end is indicated with a small hand). The rope 12 is passed via the drive source 11 by means of which the weight is lowered/lifted. The drive source 11 can e.g. be electrically-driven, air-driven, manually operated or comprise a small internal combustion engine.

In the example shown in FIG. 15b, the rope 12 or wire rope from the hoist mechanism is passed via a pulley connected to a clamp which is positioned on the upper part of the area to be inspected, e.g. the cargo tank. One end of the rope 12 is secured to e.g. a climbing harness, a platform, a box (indicated by the weight symbol), and the other end is free (indicated by the hand). Also with this arrangement, the service person, platform or box can be lifted to the upper part of the cargo tank by means of the drive source 11 to perform the inspection. This method of lifting can also be applied to the larger platform as described e.g. with respect to FIGS. 1 to 7.

In the example shown in FIG. 15c, the drive source 11 is moving together with the weight, i.e. the platform, box, personnel with our without chair. One end of the rope 12 is attached to an anchor point at the upper part of the cargo tank and the other end is free (the free end is marked with small hand in the drawing). The weight is attached directly to the drive source 11. The drive source 11 can e.g. be electrically-driven, air-driven, manually operated or comprise a small internal combustion engine.

FIGS. 9 to 11 schematically show different types of clamps which can be used in the method according to the invention. FIG. 9 is a front view of a clamp for attachment to a T-beam, FIG. 10 is a front view of a clamp for attachment to an L-beam, and FIG. 11 is a front view of a clamp for attachment to Holland profile type beams.

FIGS. 12a, 12b, 13a and 13b show different types of trolleys. FIG. 12a is a front view of a trolley (having a D-shackle) for attachment to a T-beam, and FIG. 12b is the side view thereof. As can be seen, this trolley has a chain wheel at one side for moving the trolley along the beam. The chain wheel is rotated by a chain if manually operated or by an electric-operated/air-operated motor. FIG. 13a is a side view of a different type of trolley (having a D-shackle) for attachment to a T-beam, and FIG. 13b is the front view thereof.

The same method as has been described above with respect to the climbing persons can be performed in a similar way by using the drone and/or the pivotable rod as described above.

In this respect, FIG. 16 schematically shows an example of a drone 200 for use in the method. The drone 200 comprises four rotors and a clamp 210 on its upper side by means of a securing system as described above. The clamp 210 preferably comprises a locking/unlocking mechanism, as described above, which allows a remote controlled or automatically controlled locking of the clamp 210 for attaching the clamp to the upper part of the cargo tank and which allows a remote controlled or automatically controlled unlocking of the clamp 210 for releasing the clamp from the upper part of the cargo tank.

Further, FIG. 17 schematically shows an example of a pivotable rod 300 for use in the method according to the invention. The pivotable rod 300 consists of a rod 310 and a base 320 which is located on the bottom of the cargo tank. One end of the rod 310 is pivotally supported on the base 320 by means of a pivot P such that the rod 310 can be pivoted in the vertical direction around the base 320. Further, the pivot P can be configured such that it, additionally, allows a pivoting of the rod 310 in the horizontal direction. A lifting rope 330 is attached at the free end of the rod 310 and supported via a support rod 340 fixed to the rod, which lifting rope 330 is grasped by a user. Further, a clamp 400 which is preferably configured as described, i.e. which is provided with the locking/unlocking mechanism, is attached at the free end of the rod 310. For attaching the clamp 400 to e.g. a L-beam 2 of a deck (ceiling) 1 of the cargo tank, the operator pulls the lifting rope 330 such that the rod 310 pivots vertically around the base 320, thereby lifting the clamp 400 upwardly. After the operator has moved the clamp 400 to the desired attachment position at the L-beam 2, the operator operates the locking/unlocking mechanism in order to lock the clamp 400 to the L-beam 2.

1. Method for inspecting an inside room of a ship and/or performing works therein, wherein the inside room is preferably a cargo tank, a sludge tank, a ballast tank or a cargo hold, comprising the following steps:
a) inserting, through an opening preferably provided in a ceiling portion of the inside room, an accommodating apparatus for accommodating at least one person;
b) attaching at least one rope at an upper part of the inside room, wherein the at least one rope is attached at the upper part of the inside room by at least one of:
i. manual attachment;
ii. using a drone;
iii. using a pivotable rod; and
c) moving the accommodating apparatus up and down along the at least one rope for inspecting the inside room and/or performing works therein by at least one service person accommodated by the accommodating apparatus.

2. Method according to claim 1, wherein step b) includes
attaching at least one connector apparatus to the upper part of the inside room, and
a connecting the at least one rope to the connector apparatus.

3. Method according to claim 2, wherein the at least one connector apparatus is attached at the upper part of the inside room by at least one of:
i. manually attachment;
ii. using the drone;
iii. using the pivotable rod.

4. Method according to claim 2, wherein each rope is provided with an engaging mechanism at its end which is engaged with the connector apparatus for connecting the rope to the connector apparatus.

5. Method according to claim 2, wherein the connector apparatus is at least one of a clamp, a trolley and a sling.

6. Method according to claim 5, wherein the clamp comprises at least one of:
a locking/unlocking mechanism which allows at least one of a remote controlled and automatically controlled locking of the clamp for attaching the clamp to the upper part of the inside room and which allows at least one of a remote controlled and automatically controlled unlocking of the clamp for releasing the clamp from the upper part of the inside room; and
at least one of a remote controlled and an automatically controlled rope securing mechanism for securing the at least one rope to the clamp.

7. Method according to claim 5, wherein the connector apparatus is a trolley and the method further comprises the step of shifting the accommodating apparatus connected to the trolley by shifting the trolley along a structural member to which it is attached.

8. Method according to claim 2, wherein the at least one connector apparatus is attached to at least one of a beam, a flange, projection, a web frame, a drain hole, a scallop, a cutout and a hole provided in the upper part of the inside room.

9. Method according to claim 1, wherein the accommodating apparatus is provided at each longitudinal end thereof with at least one rope.

10. Method according to claim 1, wherein the accommodating apparatus is provided with at least one drive source for moving the accommodating apparatus up and down along the ropes, wherein the drive source is at least one of electrically-operated, air-operated, manually operated and operated by an internal combustion engine.

11. Method according to claim 1, wherein the accommodating apparatus is one of a platform, a box, a chair and a safety harness.

12. Method according to claim 11, wherein the accommodating apparatus is the platform which is configured such that it can be passed in a disassembled state through an opening having a diameter of equal to or less than 1400 mm×800 mm.

13. Method according to claim 12, wherein the platform is, in step a), inserted in the disassembled state, and, after insertion, assembled in the inside room.

14. Method according to claim 13, wherein the opening provided in the ceiling portion of the inside room is a manhole or an access opening.

15. Method according to claim 14, wherein the opening provided in the ceiling portion of the inside room is positioned on a deck plating of the ship.

16. Method according to claim 11, wherein the accommodating apparatus is the platform which is configured such that it in a disassembled state through an opening having a diameter of equal to or less than 400 mm×600 mm.

17. Method according to claim 16, wherein the platform is, in step a), inserted in the disassembled state, and, after insertion, assembled in the inside room.
